(19) United States
(12) Patent Application Publication
(10) Pub. No.: US 2018/0092297 A1
(43) Pub. Date: Apr. 5, 2018

(54) WORKING MACHINE AND METHOD FOR DETERMINING ABNORMAL STATE OF WORKING MACHINE

(71) Applicant: MAKITA CORPORATION, Anjo-shi (JP)

(72) Inventors: Ryo SUNAZUKA, Anjo-shi (JP); Yuji TAKAHASHI, Anjo-shi (JP); Hirokatsu YAMAMOTO, Anjo-shi (JP); Kouichi TAKEDA, Anjo-shi (JP); Shinya KOJIMA, Anjo-shi (JP)

(73) Assignee: MAKITA CORPORATION, Anjo-shi (JP)

(21) Appl. No.: 15/724,308

(22) Filed: Oct. 4, 2017

(30) Foreign Application Priority Data
Oct. 5, 2016 (JP) 2016-197439

(51) Int. Cl. A01D 34/00; G01P 15/18; G01P 15/135

(52) U.S. Cl. CPC A01D 34/006; A01D 34/68; G01P 15/135; G01P 15/18

(57) ABSTRACT

A working machine according to one aspect of the present disclosure includes a main body portion, a driving device, a working tool, a grip portion and a determiner. The grip portion is attached to the main body portion and configured to be held by a user of the working machine. The determiner is configured to determine an abnormal state of the working machine when a couple moment received by the user through the grip portion exceeds a couple threshold. The couple threshold is 200 N·m per 50 ms.

### CROSS-REFERENCE TO RELATED APPLICATIONS

The present application claims the benefit of Japanese Patent Application No. 2016-197439 filed on Oct. 5, 2016 with the Japan Patent Office, the entire disclosure of which is incorporated herein by reference.

### BACKGROUND

The present disclosure is related to a working machine that performs work by driving a working tool.

Various types of working machines are known wherein the working machines each performs a type of work corresponding to a working tool provided to a tip of a grip portion held by an operator by driving the working tool by the power of, for example, a motor or an internal combustion engine. During the work with such a working machine, an abnormal state of the working machine may occur wherein normal use of the working machine by an operator is disturbed. One such abnormal state is a kickback in which the working tool rebounds, when the working tool hits a hard object, such as rock or wood, in reaction to the hitting.

To deal with this issue, Japanese Patent No. 4754859 discloses an electric mower that is provided with an impact sensor in a pipe and that determines occurrence of an abnormal state when the level of an impact detected by the impact sensor exceeds a specified value.

### SUMMARY

However, the level of an impact that is detected when the working tool hits a hard object and the magnitude of the force applied, in reaction to the hitting, to an operator holding the working machine are not always the same. Even if the same levels of impacts are detected, the magnitude of the force applied to an operator is smaller in the case of a working machine with a shorter distance from the working tool to the grip portion as compared to a working machine with a longer distance. That is, even if the level of impact is the same, depending on the working machine, the operator may be able to support the working machine and continue normal use of the working machine, or the operator may not be able to support the working machine and continue normal use of the working machine.

It is desirable that one aspect of the present disclosure provides a working machine configured to be able to determine an abnormal state that interrupts a normal use of the working machine by an operator in accordance with a specific determination criterion that can be applied to working machines with different sizes.

A working machine according to one aspect of the present disclosure includes a main body portion, a driving device, a working tool, a grip portion, and a determiner. The driving device is attached to the main body portion and configured to rotate so as to generate rotational force. The working tool is attached to one end of the main body portion so as to be driven by the rotational force generated by the driving device. The grip portion is attached to the main body portion and configured to be held by a user of the working machine. The determiner is configured to determine that the working machine is in an abnormal state when a couple moment received by the user through the grip portion exceeds a couple threshold. The couple threshold is 200 N·m per 50 ms.

One aspect of the present disclosure focuses on the fact that it depends on the magnitude of the couple moment received by a user through the grip portion whether a user cannot support the working machine and the working machine swings when the working tool hits an object. The couple moment is a value that corresponds to the distance from the working tool to the grip portion, that is, a value in which an individual difference of the working machine is considered. Accordingly, by using the couple moment received by a user through the grip portion as a determination criterion, an abnormal state in which normal use of the working machine by a user is disturbed can be determined in accordance with a specific determination criterion that is not distinct for each working machine.

The working machine may further includes a rotation speed detector configured to detect rotational speed of the driving device. In this case, the determiner may be configured to determine whether the couple moment estimated based on (i) an inertia of the working tool set in advance, (ii) a variation in the rotation speed of the driving device detected by the rotation speed detector, and (iii) a distance from the working tool to the grip portion exceeds the couple threshold.

When the working tool hits an object, the rotation speed of the working tool changes and a couple corresponding to the change in the rotation speed is applied to the working tool. The couple is estimated from the inertia of the working tool and the variation in the rotation speed of the driving device. The couple moment is estimated from the estimated couple and the distance from the working tool to the grip portion. Accordingly, the couple moment can be estimated from the inertia of the working tool, the variation in the rotation speed, and the distance from the working tool to the grip portion, and whether the couple moment exceeds the couple threshold can be determined.

The working machine may further include a rotation speed detector configured to detect rotational speed of the driving device and an estimate device configured to estimate an inertia of the working tool. In this case, the determiner may be configured to determine whether the couple moment estimated based on (i) the inertia estimated by the estimate device, (ii) the variation in the rotation speed detected by the rotation speed detector, and (iii) the distance from the working tool to the grip portion exceeds the couple threshold.

In this case, the inertia of the working tool is estimated. Accordingly, even in a case where multiple types of working tools are replaced and attached to the main body portion, whether the couple moment exceeds the couple threshold can be determined for each of the working tools.

The determiner may be configured to set the variation in the rotation speed produced when the couple moment reaches the couple threshold to a rotation threshold and to determine that the couple moment exceeds the couple threshold when the variation in the rotation speed in a specified period exceeds the rotation threshold.

Due to the above-described structure, whether the couple moment exceeds the couple threshold can be determined by detecting the variation in the rotation speed.

The working machine may further include a stopper configured to stop the driving device when the determiner determines the abnormal state of the working machine.

Accordingly, driving of the working tool is stopped when an abnormal state is determined. As a result, safety of the user can be ensured.

The driving device may include an internal combustion engine including a crankshaft. The working machine may further include a cell motor configured to generate driving force that initiates rotation of the crankshaft.

With the cell motor, the internal combustion engine can be easily brought to the driving state from the stationary state. Consequently, when an abnormal state is determined and the internal combustion engine is stopped, driving the working tool can be easily resumed.

Moreover, the main body portion may include an axial center. The working tool may include a rotating surface. The working machine may further include an impact detector configured to detect a magnitude of an impact applied to the working machine in a direction perpendicular to the axial center and the rotating surface. The determiner may be further configured to determine the abnormal state of the working machine when the magnitude of the impact detected by the impact detector exceeds an impact threshold set in advance.

If the user falls while working with the working machine, normal use of the working machine by the user is disturbed. Accordingly, a case where the user falls can be also determined as an abnormal state of the working machine. In an event where the user falls, the rear end of the working machine falls and a large impact is applied to the working machine in a direction perpendicular to the axial center of the main body portion and the rotating surface of the working tool. Accordingly, by detecting a magnitude of an impact applied to the working machine in the direction perpendicular to the axial center of the main body portion and the rotating surface of the working tool, a case where a user falls can be also determined to be an abnormal state of the working machine. When a kickback occurs, an impact is applied to the working machine in a direction perpendicular to the axial center of the main body portion and parallel to the rotating surface of the working tool.

Moreover, the driving device may include a motor. The working machine may further include a current detector configured to detect a magnitude of a current flowing in the motor. The estimate device may be configured to estimate the inertia based on a magnitude of an inrush-current of the motor. The inrush-current may be the current detected by the current detector when rotation of the motor is initiated.

The inertia of the working tool increases with the inrush-current of the motor. Accordingly, the inertia of the working tool can be estimated from the detected inrush-current. Moreover, the main body portion may have a rod shape. Furthermore, the grip portion may have a U-shape.

Another aspect of the present disclosure provides a method for determining an abnormal state of a working machine. The method includes detecting, estimating, and determining. The detecting involves detection of rotation speed of the driving device of the working machine. The driving device is attached to a main body portion of the working machine and configured to rotate so as to generate rotational force. The estimating involves estimation of a couple moment received by a user of the working machine through a grip portion based on (i) an inertia of a working tool, (ii) a variation in the detected rotation speed, and (iii) a distance from the working tool to the grip portion. The working tool is attached to a first end of the main body portion and configured to be driven by the rotational force generated by the driving device. The grip portion is attached to the main body portion and configured to be held by the user. The determining involves determination that the working machine is in the abnormal state when the estimated couple moment exceeds 200N·m per 50 ms.

### BRIEF DESCRIPTION OF THE DRAWINGS

An example embodiment of the present disclosure will be described hereinafter by way of example with reference to the accompanying drawings, in which:

FIG. 1 is a perspective view showing a grass cutter according to one embodiment;

FIG. 2 is a block diagram showing the structure of a motor drive device;

FIG. 3 is a flowchart illustrating a motor control process executed by a control circuit;

FIG. 4 is a time chart illustrating the rotation speed of a motor;

FIG. 5 is a flowchart illustrating a kickback determination process executed by the control circuit;

FIG. 6 is a flowchart illustrating a process for setting rotation threshold executed by the control circuit; and

FIG. 7 is a sectional view showing the internal structure of an engine drive mechanism.

### DETAILED DESCRIPTION OF THE PREFERRED EMBODIMENTS

### First Embodiment

### 1. Structure

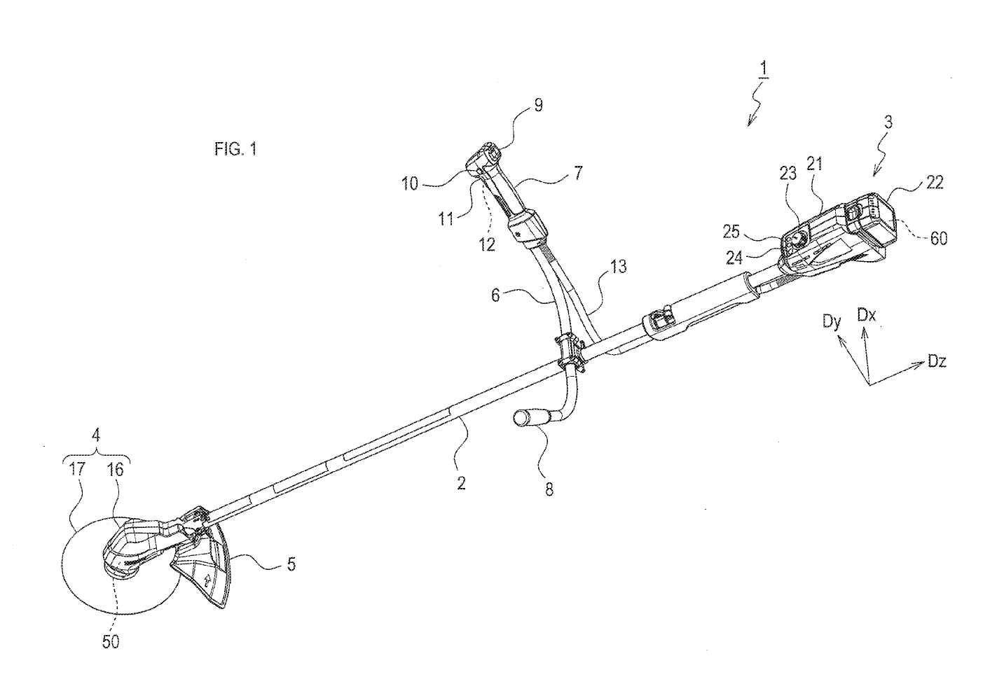

The present example embodiment describes a case where the technique according to one aspect of the present disclosure is applied to a grass cutter 1 as shown in FIG. 1. The grass cutter 1 includes a main pipe 2, a controller 3, a drive mechanism 4, a cover 5, and a handle 6. The main pipe 2 is formed in a long and hollow rod-like manner. The controller 3 is disposed in the rear end side of the main pipe 2. The drive mechanism 4 and the cover 5 are disposed in the front end side of the main pipe 2. The grass cutter 1 in the present embodiment is one example of a working machine according to the present disclosure.

The drive mechanism 4 includes a motor housing 16 and a cutting blade 17. The cutting blade 17 is a working tool configured to cut an object to be cut off such as grass and small-diameter wood (hereinafter, to be referred to as grass or the like) and to be attachable to or detachable from the motor housing 16. The cutting blade 17 is made of metal and has a disc shape. Saw bladed teeth are formed over the entire outer periphery of the cutting blade 17. The cover 5 is provided so as to inhibit grass or the like cut off by the cutting blade 17 front flying toward a user (hereinafter, an operator) of the grass cutter 1.

A motor 50 is mounted inside the motor housing 16 and configured to generate the rotational force so as to rotate the cutting blade 17. The rotational force generated by driving the motor 50 is transmitted via a deceleration mechanism to the rotation shaft of the working tool to which the cutting blade 17 is attached.

An operator can cut grass or the like by abutting the peripheral portion of the cutting blade 17 on grass or the like while the cutting blade 17 is rotated by the rotational force of the motor 50, and thereby can carry out grass-cutting work.

Instead of the cutting blade 17, a nylon cord can be adapted to the grass cutter 1 as a working tool to cut grass or the like. In this case, a nylon cord assembly may be attached to the motor housing 16 in place of the cutting blade 17.

The handle 6 is formed in a letter-U shape and coupled to the main pipe 2 in the vicinity of the midpoint of the length of the main pipe 2. A right grip 7 is provided in a first end side of the handle 6 to be held in an operator's right hand. A left grip 8 is provided in a second end side of the handle 6 to be held in the operator's left hand.

Disposed at the upper end of the right grip 7 are a forward-reverse changeover switch 9, a lock-off button 10, and a trigger 11. The forward-reverse changeover switch 9 is configured to change the rotational direction of the motor 50, that is, the rotational direction of the cutting blade 17, into either forward direction or reverse direction. The forward direction is set to cut grass or the like, whereas the reverse direction is set so as to remove grass or the like that is entangled with the cutting blade 17.

The trigger 11 is configured to be operated by an operator so as to command the cutting blade 17 to rotate or to stop. Disposed inside the right grip 7 is a trigger switch 12 that is operated in conjunction with the trigger 11. The trigger switch 12 is in an ON-state while the trigger 11 is being operated and is in an OFF-state when the trigger 11 is not operated. The trigger switch 12 outputs a trigger signal TS that indicates its ON/OFF state.

The lock-off button 10 is configured to prevent and inhibit the cutting blade 17 from being unintentionally operated. While the lock-off button 10 is not pressed, the lock-off button 10 is mechanically engaged with the trigger 11. The movement of the trigger 11 is thereby restricted so as to prevent and inhibit the trigger switch 12 from going into the ON-state. While the lock-off button 10 is pressed, the engagement of the lock-off button 10 with the trigger 11 is released.

Disposed between the lower end of the right grip 7 and the front end of the controller 3 is a control wire pipe 13. The control wire pipe 13 is formed in a hollow rod-like shape and a harness is disposed therein for control purposes. The harness is wiring that electrically couples the trigger switch 12 and the forward-reverse changeover switch 9 with the controller 3.

The controller 3 includes a rear housing 21 and a battery pack 22. The battery pack 22 is configured to be attachable to and detachable from the rear end portion of the rear housing 21.

The battery pack 22 houses a battery 60. The battery 60 is a power source configured to be repeatedly rechargeable and to supply electric power to each component inside the rear housing 21 and to the motor 50. The battery 60 is a repeatedly rechargeable power source and includes, for example, a lithium ion rechargeable battery. The rated voltage of the battery 60 may be, for example, 18V.

A speed adjustment dial 23 and a main switch 24 are disposed in the front end side of the rear housing 21 in a manner accessible to an operator for operation. Moreover, an indicator 25 configured to notify an operator the operation state, an abnormality, and the like is provided in a manner visible to the operator.

The speed adjustment dial 23 is provided so that an operator can variably set the rotation speed of the motor 50.

The main switch 24 is a switch to start power supply from the battery 60 to each of the components so that the grass cutter 1 goes into a usable state.

The indicator 25 includes a pilot lamp that is turned on when the main switch 24 is switched on and power is supplied to each component of the grass cutter 1, a pilot lamp for remaining energy that indicates the remaining energy of the battery 60, and a pilot lamp for reverse rotation that indicates reverse rotation of the motor 50. The aforementioned remaining energy means the amount of electric power remaining in the battery 60.

Disposed within the rear housing 21 is a motor drive device 30. The motor drive device 30 is configured to mainly perform motor control so as to control the rotation speed of the motor 50 by controlling the power supply to the motor 50.

The motor 50 of the present embodiment is one example of the driving device according to the present disclosure. The cutting blade 17 of the present embodiment is one example of the working tool according to the present disclosure. The main pipe 2 of the present embodiment is one example of the main body portion according to the present disclosure. The handle 6 of the present embodiment is one example of the grip portion according to the present disclosure.

### 2. Motor Drive Device

Subsequently, the structure of the motor drive device 30 will be described.

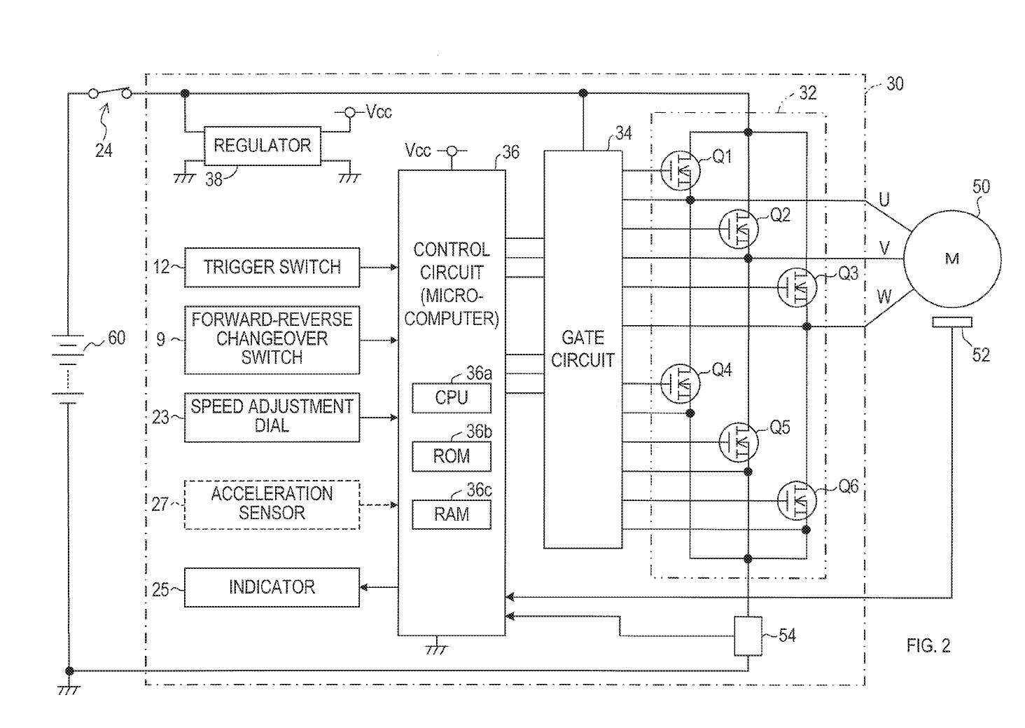

As shown in FIG. 2, the motor drive device 30 is coupled to the battery 60 via the main switch 24. The motor drive device 30 becomes capable of driving the motor 50 when the main switch 24 is switched on and electric power is supplied from the battery 60.

The motor drive device 30 includes a driving circuit 32, a gate circuit 34, a control circuit 36, and a regulator 38.

The driving circuit 32 is configured to receive power supply from the battery 60 and to flow an electric current to each winding corresponding to each phase of the motor 50. The motor 50 is a three-phase brushless motor. The driving circuit 32 is a three-phase full bridge circuit including switching elements Q1 to Q3 in the high-side and switching elements Q4 to Q6 in the low-side. The switching elements Q1 to Q6 are each constituted with, for example, a MOSFET, however are not limited to the same.

The gate circuit 34 is configured to switch on or off each of the switching elements Q1 to Q6 in accordance with a control signal outputted from the control circuit 36 and configured to flow a current sequentially to the winding for each phase of the motor 50 so as to rotate the motor 50. When the switching elements Q1 to Q6 are all switched off, the motor 50 goes into a free-running, state. When the switching elements Q1 to Q3 are all switched off and the switching elements Q4 to Q6 are all switched on, the motor 50 falls into a state where so-called short-circuit brake is applied to the motor 50.

The regulator 38 receives power supply from the battery 60 when the main switch 24 is on and generates specified power supply voltage Vcc (for example, DC 5V) that is necessary to operate the control circuit 36.

The control circuit 36 includes a microcontroller including a CPU 36a, a ROM 36b, and a RAM 36c. Coupled to the control circuit 36 are the above-described trigger switch 12, the forward-reverse changeover switch 9, the speed adjustment dial 23, and the indicator 25.

In the motor drive device 30, disposed in a current conduction path extending from the driving circuit 32 to the negative electrode of the battery 60 is a current detection circuit 54 configured to detect a value of a current flowing to the motor 50. In the vicinity of the motor 50, a rotation sensor 52 is disposed so as to detect the rotational position of a rotor included in the motor 50. An example of the rotation sensor 52 may include an optical encoder, a magnetic encoder, or the like. To the control circuit 36, detection signals transmitted respectively from the current detection circuit 54 and the rotation sensor 52 are also inputted. The rotation sensor 52 of the present embodiment is one example of the rotation speed detector according to the present disclosure.

The control circuit 36 is operated upon receiving power supply from the regulator 38. When the trigger switch 12 is operated, the control circuit 36 obtains the rotational position and the rotation speed of the motor 50 based on a rotation detection signal from the rotation sensor 52. In accordance with the setting of the forward-reverse changeover switch 9 and the speed adjustment dial 23, the control circuit 36 drives the motor 50 at specified rotation speed in a specified rotational direction. Specifically, the control circuit 36 changes the duty ratio of a control signal to be outputted from the control circuit 36 to the gate circuit 34 so as to control the rotation speed of the motor 50. Moreover, the control circuit 36 changes the timing to switch on or off the switching elements Q1 to Q6 so as to change the rotational direction or the braking state.

In addition to the above-described drive process for driving the motor 50, the control circuit 36 executes a lighting process to turn on a lighting LED, a displaying process to display the remaining energy of the battery 60 on the indicator 25, and the like. Among these processes, only the drive process will be described here.

The control circuit 36 of the present embodiment is one example of the determiner and the stopper according to the present disclosure. The rotation sensor 52 of the present embodiment is one example of the rotation speed detector according to the present disclosure

### 3. Drive Process

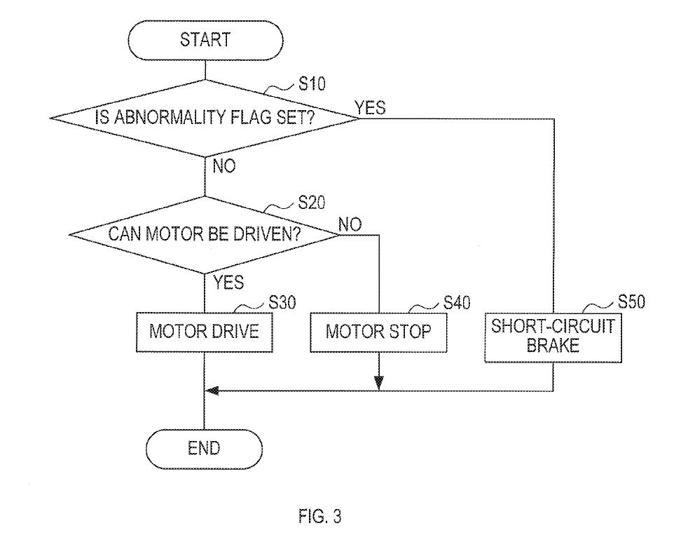

The following describes the drive process of the motor 50 executed by the control circuit 36 with reference to the flowchart in FIG. 3. When the main switch 24 is switched on, the CPU 36a repeatedly executes the drive process of the motor 50 in a cycle specified in advance (for example, 1 ms).

When the present process is initiated, in S10 (S represents a step), the CPU 36a determines whether an abnormality flag has been set. The abnormality flag is set when it is determined, in a kickback determination process which will be described later, that a kickback has occurred to the degree that normal use of the grass cutter 1 by an operator is disturbed. In other words, the abnormality flag is set when it is determined that reaction of the kickback has been received to the degree that an operator cannot keep supporting the grass cutter 1.

In S10, if it is determined that the abnormality flag has not been set, the process proceeds to S20 wherein it is determined whether the motor 50 can be driven. Specifically, it is determined whether the trigger switch 12 is in the ON-state and the requirements to drive the motor 50 have been met. The requirements for driving the motor 50 include a requirement for the remaining energy of the battery 60 being equal to or larger than a specified amount and/or other requirements.

In S20, if it is determined that the motor 50 can be driven, the process proceeds to S30 wherein driving of the motor 50 is initiated via the gate circuit 34. On the other hand, if it is determined in S20 that the motor 50 cannot be driven, the process proceeds to S40, and the motor 50 is stopped. In S40, in accordance with the product specification of the grass cutter 1, damping brake is applied to the motor 50. For example, in accordance with the product specification, short-circuit brake is applied to the motor 50 after free-running, or immediately.

On the other hand, if it is determined in S10 that the abnormality flag has been set, the process proceeds to S50 wherein short-circuit brake is immediately applied to the motor 50 for safety. As a result of applying short-circuit brake, the rotation speed of the motor 50 is reduced by strong braking force, and the motor 50 stops in a short period of time. Then, the present process is temporarily terminated. The process in S50 in the present embodiment is one example of the process executed by the stopper according to the present disclosure.

### 4. Kickback Determination Process

Next, the outline of the kickback determination process executed by the control circuit 36 will be described. A kickback is an abnormal state in which normal use of the grass cutter 1 by an operator is disturbed. A kickback is a phenomenon in which the cutting blade 17 rebounds in reaction to the cutting blade 17 of the grass cutter 1 hitting a hard object, such as rock or wood.

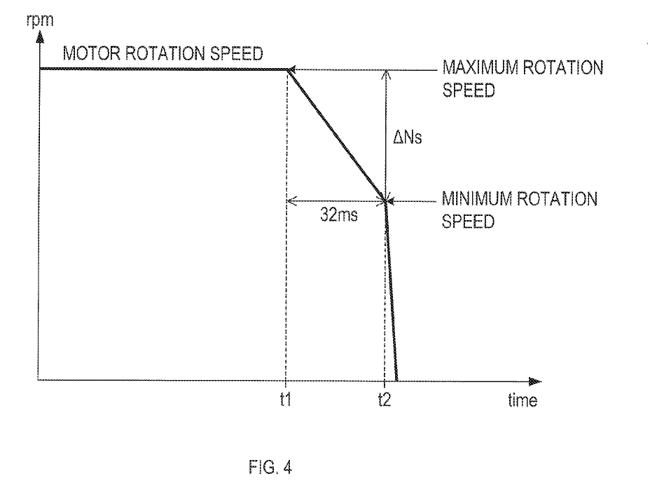

In the present embodiment, an abnormal state of the grass cutter 1 is determined based on a couple moment M applied to the grass cutter 1. As shown in FIG. 4, when the cutting blade 17 hits an object at time t1, the rotation speed of the cutting blade 17 starts decreasing. At this time, the force corresponding to the decrease in the rotation speed is applied to the cutting blade 17. The force applied to the cutting blade 17 is applied to the handle 6 as a couple F. The couple moment M [N·m]=F[N]×L[m], which corresponds to the couple F[N] and the distance L[m] from the cutting blade 17 to the handle 6, is applied to an operator holding the handle 6.

In a case where the couple moment M is relatively small, an operator can resist the reaction and hold the grass cutter 1 so as to continue the normal use of the grass cutter 1. Contrarily, in a case where the couple moment M is relatively large, the operator cannot resist the reaction and thereby becomes unable to support the grass cutter 1 and unable to continue the normal use of the grass cutter 1. It has been found from an experiment or simulation conducted by the inventors that the couple threshold of the couple moment M at which normal use of the grass cutter 1 by an operator becomes impossible is 200 [N·m] per 50 [ms]. Accordingly, when the couple moment M applied to an operator exceeds the couple threshold, an abnormal state of the grass cutter 1 may be determined and then the abnormality flag may be set.

As described above, the value of the couple moment M corresponds to a variation in the rotation speed of the cutting blade 17, that is, a variation in the rotation speed of the motor 50. Specifically, the couple F is expressed by F=K×Ip×(ΔNs/ΔT) wherein the inertia of the cutting blade 17 is represented by Ip[×10⁻⁴ kg·m²], a variation in the rotation speed within a time period ΔT [s] represented by ΔNs [rpm], and K is a coefficient. Here, the rotation speed is defined to be the number of rotations of the motor 50 per minute.

Accordingly, it can be determined that the grass cutter 1 is in an abnormal state by estimating the couple M from the inertia Ip of the cutting blade 17 and the variation ΔNs in the rotation speed and by determining whether the couple moment M exceeds the couple threshold. In a case where the cutting blade 17 to be used is decided in advance, the inertia Ip and the coefficient K may be set in advance. As shown in FIG. 4, whether the couple moment M exceeds the couple threshold can be determined based on the variation ΔNs in the rotation speed of the motor 50 within a specified time period ΔT that is set in advance.

However, the rotation speed of the motor 50 also decreases for a short period of time even in a normal cutting operation, that is, for example, when the grass cutter 1 cuts a large root or wood. When the grass cutter 1 performs normal cutting operation, the rotation speed of the motor 50 once decreases and then recovers. Thus, if the time period ΔT is too short, it may be determined that the grass cutter 1 is in an abnormal state before the grass cutter 1 goes back to the normal cutting operation. Accordingly, the time period ΔT is set to be such a length of period that the grass cutter 1 is not determined to be in an abnormal state due to the decrease in the rotation speed of the motor 50 in a normal cutting operation. In other words, the time period ΔT is set, in the case of a normal cutting operation of the grass cutter 1, longer than the period of time between when the rotation speed of the motor 50 starts decreasing and when the rotation speed of the motor 50 starts recovering. The time period ΔT may be, for example, 32 [ms]. If the value of the time period ΔT is a power of two, the value of the time ΔT is suitable for the calculation process executed by the control circuit 36 of the CPU 36a and thus the time required for the calculation process can be shortened.

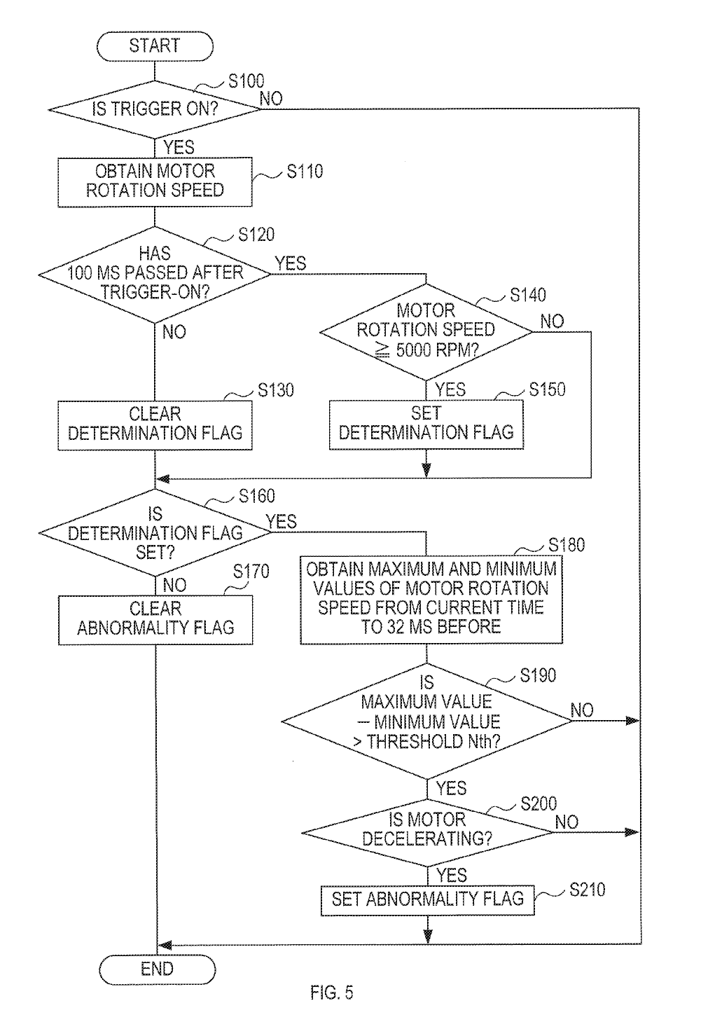

The following describes the kickback determination process executed by the control circuit 36 with reference to the flowchart in FIG. 5. When the main switch 24 is switched on, the CPU 36a repeatedly executes the kickback determination process in a cycle specified in advance.

When the present process is initiated, in S100, the CPU 36a first determines whether the trigger switch 12 has been switched from the OFF-state to the ON-state. In S100, if it is determined that the trigger switch 12 is determined to be still in the OFF-state, the present process is temporarily terminated. On the other hand, if it is determined in S100 that the trigger switch 12 has been switched to the ON-state, the process proceeds to S110 wherein the rotation speed of the motor 50 is obtained based on a rotation detection signal from the rotation sensor 52.

Subsequently in S120, it is determined whether 100 ms has passed after a switchover of the trigger switch 12 from the OFF-state to the ON-state. In other words, it is determined whether a transition period has passed after the initiation of driving of the motor 50 and the stabilization in the rotation speed of the motor 50. It is to be noted that 100 ms is one example of the determination value and the determination value may be set in accordance with the specification of the motor 50.

In S120, if it is determined that 100 ms has not yet passed, the process proceeds to S130 wherein a determination flag is cleared, and then the process proceeds to S160. The determination flag indicates whether a kickback determination is to be performed in the subsequent process. The determination flag is set if a kickback determination is to be performed.

On the other hand, in S120, if it is determined that 100 ms has passed, the process proceeds to S140 wherein it is determined whether the rotation speed of the motor 50 is equal to or larger than 5000 rpm. If the value of the rotation speed of the motor 50 when a kickback occurs is smaller than the variation ΔNs in the rotation speed the value of the rotation speed corresponding to the couple threshold, no couple moment that exceeds the couple threshold is generated. In S140, it is determined whether the rotation speed of the motor 50 has reached specific rotation speed at which the couple moment M beyond the couple threshold is to be produced if a kickback occurs. It is to be noted that 5000 rpm is one example of the determination value and the various determination values may be set depending on the working tool.

In S140, if it is determined that the rotation speed of the motor 50 is equal to or larger than 5000 rpm, the process proceeds S150 wherein the determination flag is set, and then the process proceeds to S160. On the other hand, if it is determined in S140 that the rotation speed of the motor 50 is smaller than 5000 rpm, the process proceeds directly to S160.

Subsequently in S160, it is determined whether the determination flag is set. If it is determined in S160 that the determination flag is not set, the process proceeds to S170 wherein the abnormality flag is cleared, and then the present process is temporarily terminated.

On the other hand, if it is determined in S160 that the determination flag is set, the process proceeds to S180. In S180, the maximum value and the minimum value of the rotation speed of the motor 50 in a period between the current time and the time period ΔT before the current time, that is, within the immediate 32 ms, are obtained.

Subsequently, in S190, it is determined whether the difference between the maximum value and the minimum value of the rotation speed of the motor 50 obtained in S180, that is, whether the variation ΔNs in the rotation speed is larger than a rotation threshold Nth. Based on the inertia Ip and the distance L set in advance, the rotation threshold Nth is set to the variation ΔNs in the rotation speed when the value of the couple moment M reaches the couple threshold. In the present embodiment, the rotation threshold Nth may be, for example, 7225 rpm. In other words, in S190, it is determined whether the couple moment M estimated based on the variation ΔNs in the rotation speed, the inertia Ip, and the distance L exceeds the couple threshold.

If it is determined in S190 that the variation ΔNs in the rotation speed is equal to or smaller than the rotation threshold Nth, the present process is temporarily terminated. On the other hand, if it is determined in S190 that the variation ΔNs in the rotation speed is larger than the rotation threshold Nth, the process proceeds to S200.

In S200, it is determined whether the motor 50 is decelerating. Specifically, in a case where the minimum value obtained in S180 is newer data than the maximum value obtained in S180, it is determined that the motor 50 is decelerating.

If it is determined in S200 that the motor 50 is not decelerating, the present process is temporarily terminated. On the other hand, if it is determined in S200 that the motor 50 is decelerating, the process proceeds to S210 wherein the abnormality flag is set. FIG. 4 illustrates a state in which at time t2, the abnormality flag is set and short-circuit brake is applied. Then, the present process is temporarily terminated. It is to be noted that, in the present embodiment, the aforementioned kickback determination process is one example of the process executed by the determiner according to the present disclosure.

### 5. Effect

The following effects can be achieved according to the first embodiment described above in detail.

Effect (1): The couple moment M received by an operator through the handle 6 is used as a determination criterion in a kickback determination. Accordingly, occurrence of a kickback that disturbs normal use of the working machine 1 by an operator can be determined in accordance with a specific determination criterion that can be applied to working machines with different sizes.

Effect (2): From the couple moment M estimated based on the inertia Ip of the cutting blade 17, the variation ΔNs of the rotation speed, and the distance L from the cutting blade 17 to the handle 6, whether the couple moment M exceeds the couple threshold can be determined.

Effect (3): When the grass cutter 1 is determined to be in an abnormal state, short-circuit brake is applied to the motor 50 so as to immediately stop driving the motor 50. Consequently, driving of the cutting blade 17 is also immediately stopped. This can ensure the safety of the operator.

### Second Embodiment

### 1. Difference from First Embodiment

The basic structure of the second embodiment is the same as the basic structure of the first embodiment. Thus, the description of the same structure as in the first embodiment will be omitted, and the difference will be mainly described here. The same reference numbers as in the first embodiment indicate the same components and the preceding description should be referred to for the description of these components.

In the aforementioned first embodiment, the inertia Ip of the cutting blade 17 is set in advance, and, in accordance with the inertia Ip, the rotation threshold Nth is also set in advance. The second embodiment is different from the first embodiment in that the control circuit 36 estimates the inertia Ip of the cutting blade 17 from an inrush-current generated when the motor 50 is started, and that, in accordance with the estimated inertia Ip, the rotation threshold Nth is set.

### 2. Rotation Threshold Setting Process

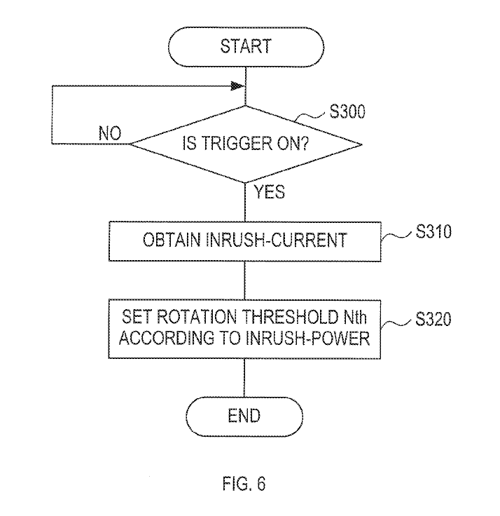

Next, a process for setting the rotation threshold Nth executed by the control circuit 36 will be described with reference to the flowchart in FIG. 6. When the main switch 24 is switched from the OFF-state to the ON-state, the CPU 36a in the control circuit 36 executes the process for setting the rotation threshold Nth once. The CPU 36a executes the drive process and the kickback determination process as described in the first embodiment separately from this setting process.

When the present process is initiated, firstly in S300, the CPU 36a determines whether the trigger switch 12 has been switched from the OFF-state to the ON-state. If it is determined in S300 that the trigger switch 12 is still in the OFF-state, the CPU 36a waits until the trigger switch 12 is switched to the ON-state.

In S300, if it is determined that the operation state of the trigger switch 12 has been switched to the ON-state, the process proceeds to S310 wherein a magnitude of an inrush-current is obtained based on a detection signal from the current detection circuit 54.

Subsequently, in S320, the inertia Ip is estimated from the inrush-current obtained in S310. Moreover, based on the distance L and the estimated inertia Ip, the variation ΔNs in the rotation speed when the value of the couple moment M reaches the couple threshold is set to the rotation threshold Nth. Then, the present process is terminated. In the present embodiment, the aforementioned process for setting the rotation threshold is one example of the process executed by the estimate device according to the present disclosure.

### 3. Effect

In addition to the effect (1) to (3) achieved in the aforementioned first embodiment, the following effect can be achieved according to the second embodiment described above in detail.

Effect (4): The inertia Ip of the cutting blade 17 is estimated so as to set the rotation threshold Nth. Accordingly, even in a case where multiple types of working tools including the cutting blade 17 are replaced and attached to the drive mechanism 4, whether the couple moment M exceeds the couple threshold can be determined for each of the working tools.

Effect (5): In a case where the inertia Ip of the cutting blade 17 is larger, the inrush-current generated when the motor 50 is started becomes larger, Accordingly, the inertia Ip of the cutting blade 17 can be estimated from the value of the detected inrush-current.

### Third Embodiment

### 1. Difference from First Embodiment

The basic structure of the third embodiment is the same as the basic structure of the first embodiment. Thus, the description of the same structure as in the first embodiment will be omitted, and the difference will be mainly described here. The same reference numbers as in the first embodiment indicate the same components and the preceding description should be referred to for the description of these components.

In the aforementioned first embodiment, the grass cutter 1 is determined to be in an abnormal state based on a variation in the rotation speed. In the third embodiment, an abnormal state of the grass cutter 1 is detected when a kickback occurs and when an operator falls, specifically a fall of the rear end of the grass cutter 1 associated with the fall of the operator. A fall of the rear end of the grass cutter 1 is detected by detecting an impact generated in conjunction with the fall.

As shown in FIG. 2 with a broken line, the motor drive device 30 in the third embodiment includes an acceleration sensor 27. The acceleration sensor 27 is disposed inside the rear housing 21 and configured to output a detection signal to the control circuit 36. As shown in FIG. 1, the direction parallel to the axis of the main pipe 2 will be referred to as the font-rear direction Dz. The direction that is perpendicular to the front-rear direction Dz and parallel to the rotating surface of the cutting blade 17 will be referred to as the left-right direction Dx. The direction that is perpendicular to both the left-right direction Dx and the front-rear direction Dz will be referred to as the up-down direction Dy. In a case where an operator performing cutting work with the grass cutter 1 falls and drops the rear end of the grass cutter 1 while working, a large impact is applied to the grass cutter 1 in the up-down direction Dy, and the grass cutter 1 is greatly accelerated in the up-down direction Dy. When a kickback occurs while grass cutting work is performed, an impact is generated on the grass cutter 1 in the left-right direction Dx, and the grass cutter 1 is accelerated in the left-right direction Dx.

The acceleration sensor 27 is disposed inside the rear housing 21 such that the detection axis of the acceleration sensor 27 aligns with the up-down direction Dy so as to detect acceleration in the up-down direction Dy. The control circuit 36 executes a falling determination process in addition to the above-described drive process and the kickback determination process. In the falling determination process, when the acceleration in the up-down direction Dy exceeds an impact threshold Ay set in advance, the control circuit 36 determines that the grass cutter 1 is in an abnormal state based on a detection signal of the acceleration sensor 27 and sets the abnormality flag. The impact threshold Ay is a determination value to determine the presence or the absence of a fall of the grass cutter 1. The acceleration sensor 27 of the present embodiment is one example of the impact detector according to the present disclosure.

The acceleration sensor 27 may be configured to be able to independently detect acceleration of two or three axes. In this case, the acceleration sensor 27 may be disposed inside the rear housing 21 such that at least two detection axes of the acceleration sensor 27 align with the up-down direction Dy and the left-right direction Dx so as to detect acceleration at least in the up-down direction Dy and the left-right direction Dx. The control circuit 36 determines that the grass cutter 1 is in an abnormal state when the acceleration in the up-down direction Dy exceeds the impact threshold Ay.

Furthermore, the control circuit 36 may be configured to determine, in the kickback determination process in S190, whether the variation ΔNs in the rotation speed exceeds the rotation threshold Nth and whether acceleration in the left-right direction Dx exceeds the impact threshold Ax. The impact threshold Ax is a determination value to determine that an impact larger than impacts in normal operation has been produced in the left-right direction Dx. In this case, the rotation threshold Nth may be changed to a value smaller than the value determined in advance based on the inertia Ip and the distance L. In S190, a requirement for acceleration in the left-right direction Dx may be added so that, even if the requirement for the variation ΔNs in the rotation speed is relaxed, occurrence of a kickback can be determined accurately to the same extent as in a case where determination is made based only on the requirement for the variation ΔNs in the rotation speed. As compared to a case where determination is made based only on the variation ΔNs in the rotation speed, making determination based on more than one detection values can inhibit inaccurate determination wherein it is determined that the grass cutter 1 is in an abnormal state despite that the grass cutter 1 is not actually in an abnormal state.

Even in a normal operation, an impact is applied to the grass cutter 1, the grass cutter 1 may be determined to be in an abnormal state despite that the grass cutter 1 is not actually in an abnormal state. Such situation may take place when a damaged string-like cutting blade is fed from a cord holder. The string-like cutting blade is wound around a spool of the cord holder as described in, for example, Unexamined Japanese Patent Application Publication No. 2013-034404. By pressing a cord feeding button disposed in the bottom portion of the spool against a ground surface, centrifugal force is applied to the string-like cutting blade wound around the spool and consequently the cutting blade is fed. Accordingly, while the grass cutter 1 is in normal operation feeding the cutting blade, an impact is applied to the grass cutter 1.

In a case where only an impact is detected, pressing the aforementioned cord feeding button against a ground surface may be determined as an abnormality. If, for example, the variation in the rotation speed is used in addition to the impact detection, an abnormal state can be more accurately determined.

In the working machine 1 according to the second embodiment, occurrence of a fall may be determined as an abnormal state of the grass cutter 1.

### 2. Effect

In addition to the effect (1) to (5) achieved in the aforementioned first and the second embodiments, the following effects can be achieved according to the third embodiment described above in detail.

Effect (6): By detecting an impact applied to the grass cutter 1, an abnormal state of the grass cutter 1 can be determined in a case where an operator falls and normal use of the grass cutter 1 by the operator is disturbed.

Effect (7): The combination of the variation in the rotation speed and an impact on the grass cutter 1 can make determination of an abnormal state of the grass cutter 1 more accurate. Accordingly, inaccurate determination where a normal operation of the grass cutter 1 is determined as an abnormal state of the grass cutter 1 can be reduced or inhibited.

### Fourth Embodiment

### 1. Difference from First Embodiment

The basic structure of the fourth embodiment is the same as the basic structure of the first embodiment. Thus, the description of the same structure as in the first embodiment will be omitted, and the difference will be mainly described here. The same reference numbers as in the first embodiment indicate the same components and the preceding description should be referred to for the description of these components.

In the aforementioned first to the third embodiments, the cutting blade 17 is driven by the rotational force of the motor 50. In the fourth embodiment, the cutting blade 17 is driven by the rotational force of an engine 200.

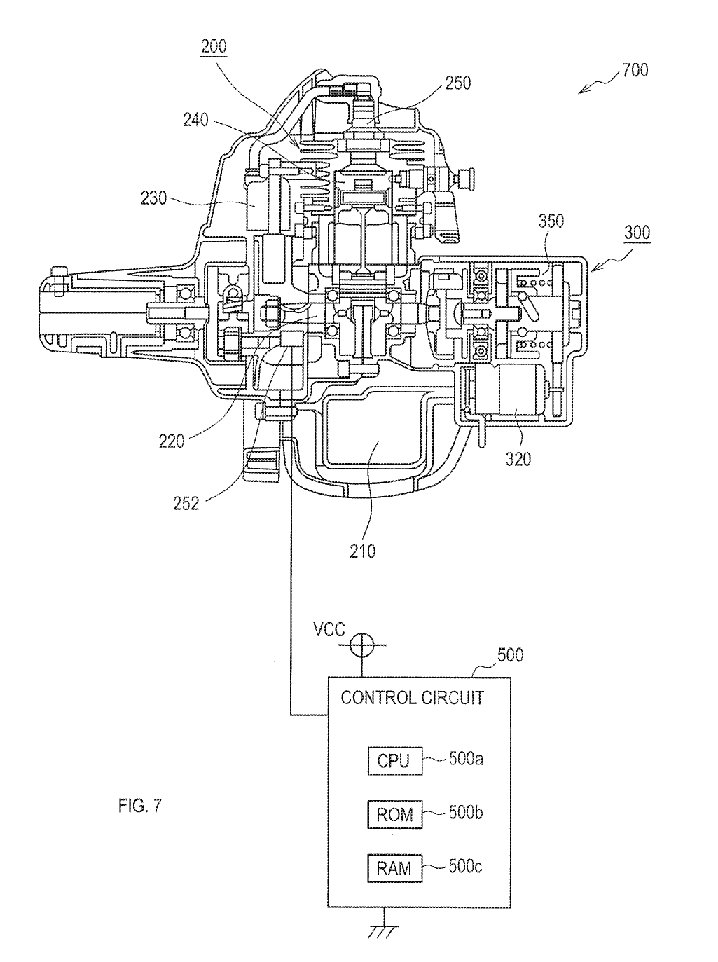

The grass cutter 1 in the fourth embodiment includes, as shown in FIG. 7, a drive mechanism 700 in the rear end side of the main pipe 2 alternatively to the controller 3. The drive mechanism 4 is not provided in the front end side of the main pipe 2. The drive mechanism 700 includes the engine 200, a cell motor device 300, and a control circuit 500.

The engine 200 is a compact two-cycle engine including a fuel tank 210, a crankshaft 220, an ignition coil 230, a piston 240, and a spark plug 250. The crankshaft 220 is coupled to the rotation shaft of the cutting blade 17 via a drive shaft extending inside the main pipe 2. Accordingly, the cutting blade 17 is driven by the rotational force of the engine 200.

The control circuit 500 includes a microcontroller including a CPU 500a, a ROM 500b, and a RAM 500c. Disposed in the vicinity of the crankshaft 220 is a crank angle sensor 252 that detects the rotational position of the crankshaft 220. To the control circuit 500, a detection signal from the crank angle sensor 252 is inputted. The control circuit 500 is configured to control and drive the engine 200. Moreover, the control circuit 500 is configured, similarly to the control circuit 36, to execute the kickback determination process based on the rotation speed of the engine 200 instead of the rotation speed of the motor 50. The engine 200 in the present embodiment is one example of the driving device according to the present disclosure. The crank angle sensor 252 in the present embodiment is one example of the rotation speed detector according to the present disclosure.

The cell motor device 300 includes a cell motor 320 and a power transmission mechanism 350. The cell motor 320 is a DC motor that generates rotational force by the electric power of a battery (not shown) and configured to provide initial rotation to the crankshaft 220 when the engine 200 is started. The power transmission mechanism 350 is disposed between the rotation shaft of the cell motor 320 and the crankshaft 220 and configured to transmit the driving force of the cell motor 320 to the crankshaft 220.

The cell motor device 300 is operated when the trigger switch 12 is switched from the OFF-state to the ON-state and transmits the rotational force to the crankshaft 220. Accordingly, the initial rotation is provided to the crankshaft 220 and the engine 200 is started.

The drive mechanism 700 may be employed in the grass cutter 1 according to the second and the third embodiments. In a case where the drive mechanism 700 is employed in the second embodiment, the control circuit 500 may estimate the inertia Ip from, for example, the rate of increase in the rotation speed when the engine 200 is started. In a case where the inertia Ip is smaller, the rate of increase in the rotation speed of the engine 200 becomes larger.

### 2. Effect

In addition to the effect (1) to (4) and (6) achieved in the aforementioned first to the third embodiments, the following effects can be achieved according to the fourth embodiment described above in detail.

Effect (8): With the cell motor 320, the engine 200 can be easily brought to the driving state from the stationary state. Consequently, when an abnormal state of the grass cutter is determined and the engine 200 is stopped, driving the cutting blade 17 can be easily resumed.

### Other Embodiments

Although the above has described embodiments to carry out the present disclosure, the present disclosure is not limited to the above-described embodiments and can be carried in various ways.

(a) In the first to the third embodiments, when an abnormal state is determined, the motor 50 is stopped with short-circuit brake; however the present disclosure is not limited thereto. Alternatively to a short-circuit brake, a mechanical brake, for example, may be used. Any type of brake that can stop the motor 50 may be used.

(b) In the second embodiment, the control circuit 36 is configured to estimate the inertia Ip from the inrush-current; however the present disclosure is not limited thereto. The control circuit 36 may be configured to estimate the inertia Ip from, for example, the rate of increase in the rotation speed of the motor 50 when the motor 50 is started. In a case where the inertia Ip is smaller, the rate of increase in the rotation speed when the motor 50 is started becomes larger.

(c) In the first to the third embodiments, the control circuit 36 may be configured to estimate the rotation speed, without a detection signal of the rotation sensor 52, but with the so-called observer system in which the rotation speed can be estimated from drive information such as a current flowing in the motor 50, voltage applied to the motor 50, or the like. In this case, alternatively to the rotation sensor 52, a voltage detection circuit that detects the voltage applied to the motor 50 may be provided.

Instead of using the crank angle sensor 252 in the fourth embodiment, the rotation speed may be detected based on a change in the magnetic flux by magnets embedded in a flywheel.

(d) The present disclosure may be employed not only in a grass cutter, but also in various working machines, such as a chainsaw, a hedge trimmer, and a trimmer, each of which is configured such that the working tool thereof is driven by rotational force.

(e) in the aforementioned embodiments, the control circuit 36 may include, alternatively to or in addition to the microcomputer, a combination/combinations of various individual electronic components. The control circuit 36 may include Application Specified Integrated Circuit (ASIC), Application Specific Standard Product (ASSP), a programmable logic device such as Field Programmable Gate Array (FPGA), or a combination of these components.

(f) A plurality of functions possessed by one component in the above-described embodiments may be achieved by a plurality of components, or one function possessed by one component may be achieved by a plurality of components. Furthermore, a plurality of functions possessed by a plurality of components may be achieved by one component, or one function achieved by a plurality of components may be achieved by one component. Moreover, the configurations of the above-described embodiments may be partially omitted. At least a part of the configurations of the above-described embodiments may be added to or altered with the configurations of other embodiments. Various aspects included in the technical ideas specified only by the languages recited in the claims correspond to the embodiments of the present disclosure.

(g) In addition to in the above-described working machine, the invention of the present disclosure can be carried out in various ways, for example, in an abnormality determination device that determines an abnormal state of a working machine, in a program that enables a computer to serve as an abnormality determination device, in a non-transitory tangible storage medium, such as a semiconductor memory in which the aforementioned program is recorded, of in a method for determining an abnormal state.

What is claimed is:

1. A working machine comprising:
a main body portion;
a driving device attached to the main body portion and configured to rotate so as to generate rotational force;
a working tool attached to one end of the main body portion so as to be driven by the rotational force generated by the driving device;
a grip portion attached to the main body portion and configured to be held by a user of the working machine; and
a determiner configured to determine an abnormal state of the working machine when a couple moment received by the user through the grip portion exceeds a couple threshold, the couple threshold being 200 N·m per 50 ms.

2. The working machine according to claim 1 further comprising a rotation speed detector configured to detect rotational speed of the driving device,
wherein the determiner is configured to determine whether the couple moment estimated based on (i) inertia of the working tool set in advance, (ii) a variation in the rotation speed of the driving device detected by the rotation speed detector, and (iii) a distance from the working tool to the grip portion exceeds the couple threshold.

3. The working machine according to claim 1 further comprising:
a rotation speed detector configured to detect rotational speed of the driving device; and
an estimate device configured to estimate an inertia of the working tool,
wherein the determiner is configured to determine whether the couple moment estimated based on (i) the inertia estimated by the estimate device, (ii) a variation in the rotation speed detected by the rotation speed detector, and (iii) a distance from the working tool to the grip portion exceeds the couple threshold.

4. The working machine according to claim 2,
wherein the determiner is configured to set the variation in the rotation speed produced when the couple moment reaches the couple threshold to a rotation threshold and to determine that the couple moment exceeds the couple threshold when the variation in the rotation speed in a specified period exceeds the rotation threshold.

5. The working machine according to claim 1 further comprising a stopper configured to stop the driving device when the determiner determines the abnormal state of the working machine.

6. The working machine according to claim 1,
wherein the driving device includes an internal combustion engine including a crankshaft, and
wherein the working machine further comprises a cell motor configured to generate driving force that initiates rotation of the crankshaft.

7. The working machine according to claim 1,
wherein the main body portion includes an axial center;
wherein the working tool includes a rotating surface;
wherein the working machine further comprises an impact detector configured to detect a magnitude of an impact applied to the working machine in a direction perpendicular to the axial center and the rotating surface; and
wherein the determiner is further configured to determine the abnormal state of the working machine when the magnitude of the impact detected by the impact detector exceeds an impact threshold set in advance.

8. The working machine according to claim 3,
wherein the driving device includes a motor;
wherein the working machine further comprises a current detector configured to detect a magnitude of a current flowing in the motor;
wherein the estimate device is configured to estimate the inertia based on a magnitude of an inrush-current of the motor; and
wherein the inrush-current is the current detected by the current detector when rotation of the motor is initiated.

9. The working machine according to claim 1 wherein the main body portion has a rod shape.

10. The working machine according to claim 1 wherein the grip portion has a U-shape.

11. A method for determining an abnormal state of a working machine, the method comprising:
detecting rotation speed of a driving device of the working machine, the driving device being attached to a main body portion of the working machine and configured to rotate so as to generate rotational force;
estimating a couple moment received by a user of the working machine through a grip portion based on (i) an inertia of a working tool, (ii) a variation in the detected rotation speed, and (iii) a distance from the working tool to the grip portion, the working tool being attached to a first end of the main body portion and configured to be driven by the rotational force generated by the driving device, and the grip portion being attached to the main body portion and configured to be held by the user; and
determining that the working machine is in the abnormal state when the estimated couple moment exceeds 200 N·m per 50 ms.
